(19) United States
(12) Patent Application Publication
(10) Pub. No.: US 2025/0389355 A1
(43) Pub. Date: Dec. 25, 2025

(54) PIPE COUPLINGS HAVING INSTALLATION INDICATORS

(71) Applicant: ASC Engineered Solutions, LLC, Oak Brook, IL (US)

(72) Inventors: Patrick Chen, North Kingstown, RI (US); Daniel Cross, South Kingstown, RI (US)

(21) Appl. No.: 19/243,428

(22) Filed: Jun. 19, 2025

Related U.S. Application Data
(60) Provisional application No. 63/662,951, filed on Jun. 21, 2024.

(51) Int. Cl. F16L 19/025; F16L 19/02

(52) U.S. Cl. CPC F16L 19/025; F16L 19/0218; F16L 2201/10

(57) ABSTRACT

Disclosed example pipe couplings include: a coupling body having a first coupling segment and a second coupling segment, the first coupling segment having a first lug on a first end and the second coupling segment having a second lug opposite the first lug; a first fastener mounted to the coupling body via the first and second lugs and configured to tighten the pipe coupling; and a first installation indicator on the first lug and arranged to overlap a first indicator face of the second lug as the pipe coupling is tightened, wherein the first installation indicator is in a predetermined alignment with a first counter indicator on the second lug when the pipe coupling is correctly-tightened and is not in the predetermined alignment with the first counter indicator when the pipe coupling is under tightened.

### RELATED APPLICATIONS

The present application claims the benefit of U.S. Provisional Patent Application Ser. No. 63/662,951, filed Jun. 21, 2024, entitled “PIPE COUPLINGS HAVING INSTALLATION INDICATORS.” The entirety of U.S. Provisional Patent Application Ser. No. 63/662,951 is expressly incorporated herein by reference.

### TECHNICAL FIELD

This disclosure relates to disclosure relates to pipe couplings and, more particularly, to pipe couplings having installation indicators.

### BACKGROUND

Pipe couplings are used to connect two sections of pipes, and/or other pipe fittings, together to form a pipe connection, such as when installing a pipe system or a pipe infrastructure. Conventional pipe couplings require tightening one or more fasteners to secure the pipe couplings to the pipe sections. In conventional pipe couplings, the fasteners are tightened to a specified degree to establish the required seal and provide rigidity of pipe joint.

### SUMMARY

Pipe couplings having installation indicators are disclosed, substantially as illustrated by and described in connection with at least one of the figures, as set forth more completely in the claims.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1 is a side view of an example pipe coupling having installation indicators, in an untightened configuration, in accordance with aspects of this disclosure.

FIG. 2 is a side view of the example pipe coupling of FIG. 1, in the untightened configuration, fitted over two pipe sections to be joined.

FIG. 3 is a side view of the example pipe coupling of FIG. 1, in a tightened configuration.

FIG. 4 is a side view of the example pipe coupling of FIG. 1, in the tightened configuration, fitted over two pipe sections to be joined.

FIG. 5 is a perspective view of the example pipe coupling of FIG. 1, in the untightened configuration, fitted over two pipe sections to be joined.

FIG. 6 is a perspective view of the example pipe coupling of FIG. 1, in the tightened configuration, fitted over two pipe sections to be joined.

FIGS. 7A-7D illustrate perspective views of one of the segments of the example pipe coupling of FIG. 1.

FIG. 8 is a perspective view of the example gasket of the pipe coupling of FIG. 1.

FIG. 9 is a cross-sectional view of a portion of the example gasket of the pipe coupling of FIG. 1.

FIG. 10 is a partial cross-sectional view of the example pipe coupling and gasket of FIG. 1, in the untightened configuration, fitted over two pipe sections to be joined.

FIG. 11 is a partial cross-sectional view of the example pipe coupling and gasket of FIG. 1, in the tightened configuration, fitted over two pipe sections to be joined.

FIGS. 12A and 12B are more detailed depictions of one of the installation indicators of the pipe coupling of FIG. 1, in the untightened configuration.

FIGS. 13A and 13B are more detailed depictions of the installation indicator of the pipe coupling of FIG. 1, in the tightened configuration.

FIGS. 14A and 14B depict a second example installation indicator that may be used to implement the installation indicators of the pipe coupling of FIG. 1, in the untightened configuration.

FIGS. 15A and 15B depict the second example installation indicator of FIGS. 14A and 14B, in the tightened configuration.

FIGS. 16A and 16B depict a third example installation indicator that may be used to implement the installation indicators of the pipe coupling of FIG. 1, in the untightened configuration.

FIGS. 17A and 17B depict the third example installation indicator of FIGS. 16A and 16B, in the tightened configuration.

FIGS. 18A and 18B depict a fourth example installation indicator that may be used to implement the installation indicators of the pipe coupling of FIG. 1, in the untightened configuration.

FIGS. 19A and 19B depict the fourth example installation indicator of FIGS. 17A and 17B, in the tightened configuration.

FIGS. 20A and 20B depict a fifth example installation indicator that may be used to implement the installation indicators of the pipe coupling of FIG. 1, in the untightened configuration.

FIGS. 21A and 21B depict the fifth example installation indicator of FIGS. 20A and 20B, in the tightened configuration.

FIGS. 22A and 22B depict a sixth example installation indicator that may be used to implement the installation indicators of the pipe coupling of FIG. 1, in the untightened configuration.

FIGS. 23A and 23B depict the sixth example installation indicator of FIGS. 22A and 22B, in the tightened configuration.

The figures are not necessarily to scale. Wherever appropriate, similar or identical reference numerals are used to refer to similar or identical components.

### DETAILED DESCRIPTION

The present disclosure can be understood more readily by reference to the following detailed description, examples, drawings, and claims, and the previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching of the present devices, systems, and/or methods in its best, currently known aspect. To this end, those skilled in the relevant art will recognize and appreciate that many changes can be made to the various aspects of the present devices, systems, and/or methods described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutations of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

Disclosed are pipe couplings having installation indicators and associated methods, systems, devices, and various apparatus. Example aspects of the pipe coupling can comprise an installation indicator for visually indicating that the pipe coupling is suitably tightened. It would be understood by one of skill in the art that the pipe coupling is described in but a few examples among many. No particular terminology or description should be considered limiting on the disclosure or the scope of any claims issuing therefrom.

According to some aspects, disclosed example pipe couplings include: a coupling body comprising a first coupling segment and a second coupling segment, the first coupling segment having a first lug on a first end and the second coupling segment having a second lug opposite the first lug; a first fastener mounted to the coupling body via the first and second lugs and configured to tighten the pipe coupling; and a first installation indicator on the first lug and arranged to overlap a first indicator face of the second lug as the pipe coupling is tightened, wherein the first installation indicator is in a predetermined alignment with a first counter indicator on the second lug when the pipe coupling is correctly-tightened and is not in the predetermined alignment with the first counter indicator when the pipe coupling is under tightened.

In some example pipe couplings, the first installation indicator of the first lug includes a cast protrusion and the first counter indicator of the second lug comprises a cast indicator. In some example pipe couplings, the first installation indicator is on an outer face of the first lug and the first indicator face is on an outer face of the second lug.

In some example pipe couplings, the first installation indicator includes at least one of a point or a first line perpendicular to a direction of tightening of the pipe coupling. In some such example pipe couplings, the first counter indicator includes a second line perpendicular to the direction of tightening of the pipe coupling. In some example pipe couplings, the first counter indicator includes a point. In some example pipe couplings, the first counter indicator includes a range in the direction of tightening of the pipe coupling, wherein the first installation indicator has the predetermined alignment with the first counter indicator when the first installation indicator is within the range.

In some example pipe couplings, the first coupling segment has a third lug on a second end and the second coupling segment has a fourth lug opposite the third lug, and the pipe coupling further includes: a second fastener mounted to the coupling body via the third and fourth lugs and configured to tighten the pipe coupling; and a second installation indicator on the fourth lug and arranged to overlap a second indicator face of the third lug as the pipe coupling is tightened, wherein the second installation indicator is in a predetermined alignment with a second counter indicator on the third lug when the pipe coupling is correctly tightened and is not in the predetermined alignment with the second counter indicator when the pipe coupling is under tightened. In some such example pipe couplings, the first coupling segment and the second coupling segment are identical. In some example pipe couplings, the first coupling segment and the second coupling segment each include a gasket groove, wherein the pipe coupling further comprises a gasket disposed within the gasket groove.

According to some aspects, disclosed example pipe couplings include: a coupling body including a first coupling segment and a second coupling segment, the first coupling segment having a first lug and a second lug, and the second coupling segment having a third lug opposite the first lug and a fourth lug opposite the second lug; a first fastener mounted to the coupling body via the first and third lugs, and a second fastener mounted to the coupling body via the second and fourth lugs, the first and second fasteners configured to tighten the pipe coupling; and installation indicators on the first coupling segment and the second coupling segment, the installation indicators configured to completely visually indicate when the pipe coupling is in a tightened configuration at two locations on the pipe coupling.

In some example pipe couplings, the installation indicators are cast into the first and second coupling segments. In some example pipe couplings, the installation indicators are on respective outer faces of the first lug and the second lug. In some example pipe couplings, the installation indicators completely visually indicate when the pipe coupling is in a tightened configuration by a predetermined alignment of the installation indicators.

In some example pipe couplings, the installation indicators are configured to visually indicate that the pipe coupling is in the tightened configuration by a lack of a gap between the installation indicators. In some example pipe couplings, the installation indicators are configured to be in an overlapping arrangement in the tightened configuration. In some example pipe couplings, the installation indicators are configured to visually indicate that the pipe coupling is in the tightened configuration by a lack of visibility of a predetermined visual indicator.

In some example pipe couplings, the installation indicators are further configured to tactilely indicate when the pipe coupling is in a tightened configuration at two locations on the pipe coupling. In some example pipe couplings, the first coupling segment and the second coupling segment are identical. In some example pipe couplings, the installation indicators further visually indicate when the pipe coupling is not in the tightened configuration.

According to some aspects, disclosed example pipe couplings include: a coupling body including a first coupling segment and a second coupling segment, the first coupling segment having a first lug on a first end and the second coupling segment having a second lug opposite the first lug; a first fastener mounted to the coupling body via the first and second lugs and configured to tighten the pipe coupling; and a first installation indicator on the first lug and arranged to overlap a first indicator face of the second lug as the pipe coupling is tightened, wherein the first installation indicator and a first counter indicator on the second lug provide a first tactile indication when the pipe coupling is correctly-tightened and a second tactile indication when the pipe coupling is under tightened.

In some example pipe couplings, the first installation indicator of the first lug includes a cast protrusion and the first counter indicator of the second lug comprises a cast indicator. In some example pipe couplings, the first installation indicator is on an outer face of the first lug and the first indicator face is on an outer face of the second lug.

In some example pipe couplings, the first installation indicator includes at least one of a point or a first line perpendicular to a direction of tightening of the pipe coupling. In some such example pipe couplings, the first counter indicator includes a second line perpendicular to the direction of tightening of the pipe coupling. In some example pipe couplings, the first counter indicator includes a point.

In some example pipe couplings, the first counter indicator has a texture etched or cut into the first indicator face. In some example pipe couplings, the first coupling segment has a third lug on a second end and the second coupling segment has a fourth lug opposite the third lug, and the pipe coupling further includes: a second fastener mounted to the coupling body via the third and fourth lugs and configured to tighten the pipe coupling; and a second installation indicator on the fourth lug and arranged to overlap a second indicator face of the third lug as the pipe coupling is tightened, wherein the second installation indicator and a second counter indicator provide a third tactile indication when the pipe coupling is correctly-tightened and a fourth tactile indication when the pipe coupling is under tightened. In some such example pipe couplings, the first coupling segment and the second coupling segment are identical.

In some example pipe couplings, the first coupling segment and the second coupling segment each include a gasket groove, wherein the pipe coupling further includes a gasket disposed within the gasket groove.

According to some aspects, disclosed example pipe couplings include: a coupling body including a first coupling segment and a second coupling segment, the first coupling segment having a first lug and a second lug, and the second coupling segment having a third lug opposite the first lug and a fourth lug opposite the second lug; a first fastener mounted to the coupling body via the first and third lugs, and a second fastener mounted to the coupling body via the second and fourth lugs, the first and second fasteners configured to tighten the pipe coupling; and installation indicators on the first coupling segment and the second coupling segment, the installation indicators configured to completely tactilely indicate when the pipe coupling is in a tightened configuration at two locations on the pipe coupling.

In some example pipe couplings, the installation indicators are cast into the first and second coupling segments. In some example pipe couplings, the installation indicators are on respective outer faces of the first lug and the second lug. In some example pipe couplings, the installation indicators completely tactilely indicate when the pipe coupling is in a tightened configuration by a predetermined alignment of the installation indicators.

In some example pipe couplings, the installation indicators are configured to tactilely indicate that the pipe coupling is in the tightened configuration by a lack of a gap between the installation indicators. In some example pipe couplings, the installation indicators are configured to be in an overlapping arrangement in the tightened configuration. In some example pipe couplings, the installation indicators are configured to tactilely indicate that the pipe coupling is in the tightened configuration by a lack of accessibility of a predetermined tactile indicator.

In some example pipe couplings, the installation indicators are further configured to tactilely indicate when the pipe coupling is in a tightened configuration at two locations on the pipe coupling. In some example pipe couplings, the first coupling segment and the second coupling segment are identical. In some example pipe couplings, the installation indicators further tactilely indicate when the pipe coupling is not in the tightened configuration.

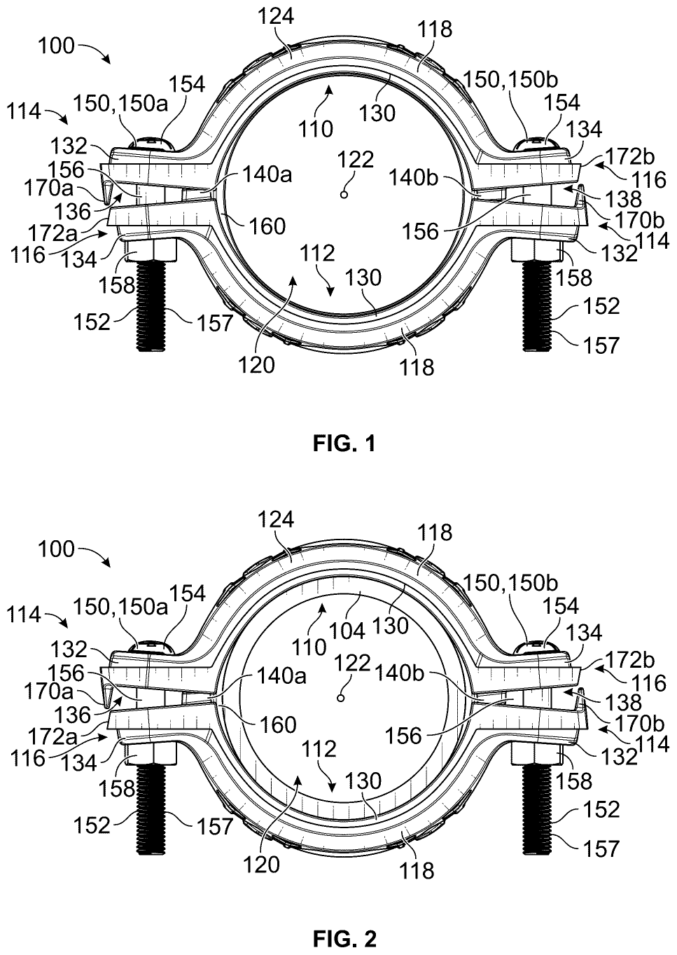

FIG. 1 is a side view of an example pipe coupling 100 having installation indicators, in an untightened configuration. FIG. 2 is a side view of the example pipe coupling 100 of FIG. 1, in the untightened configuration, fitted over two pipe sections 104 to be joined.

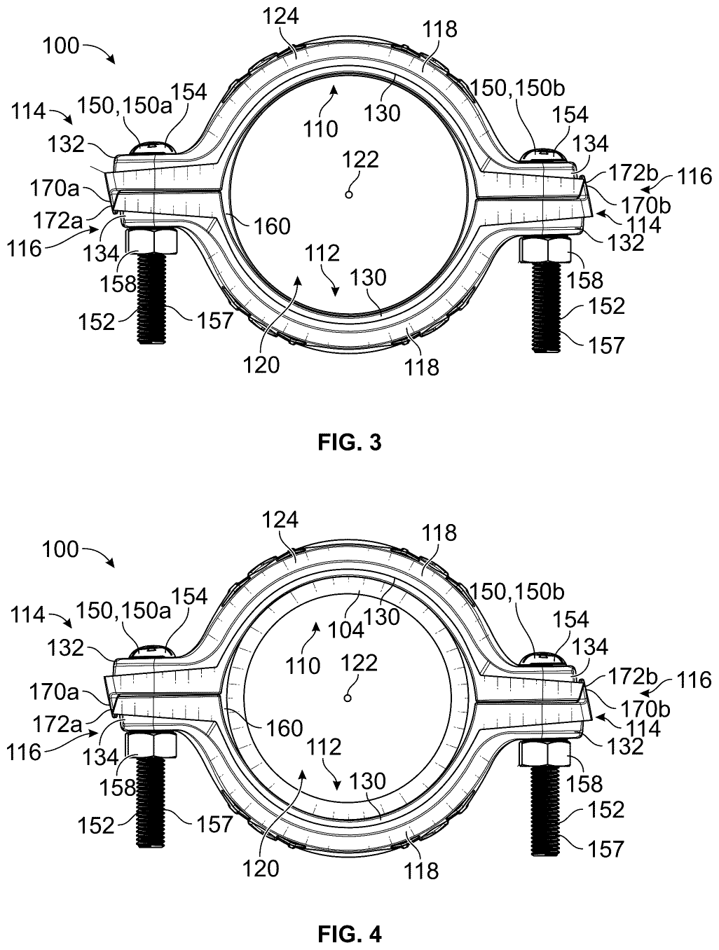

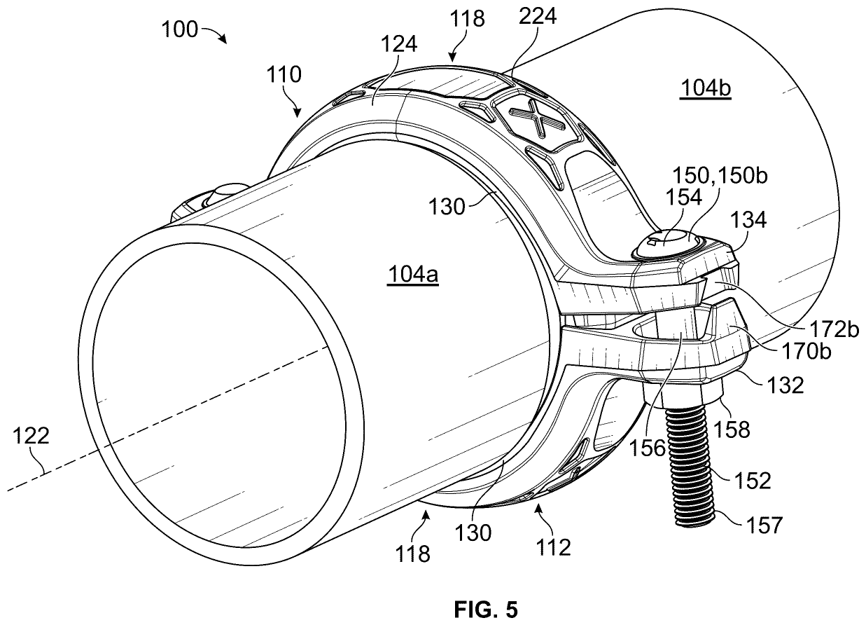

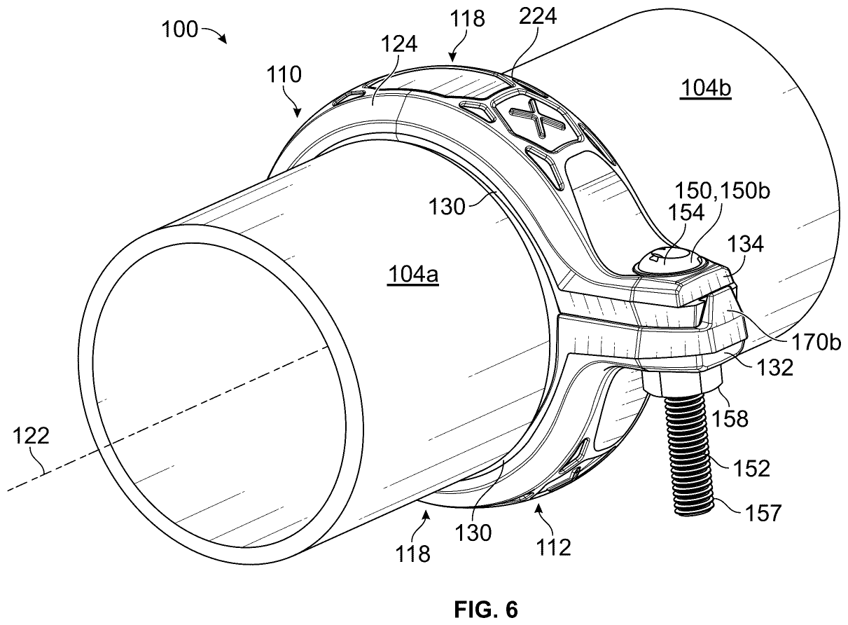

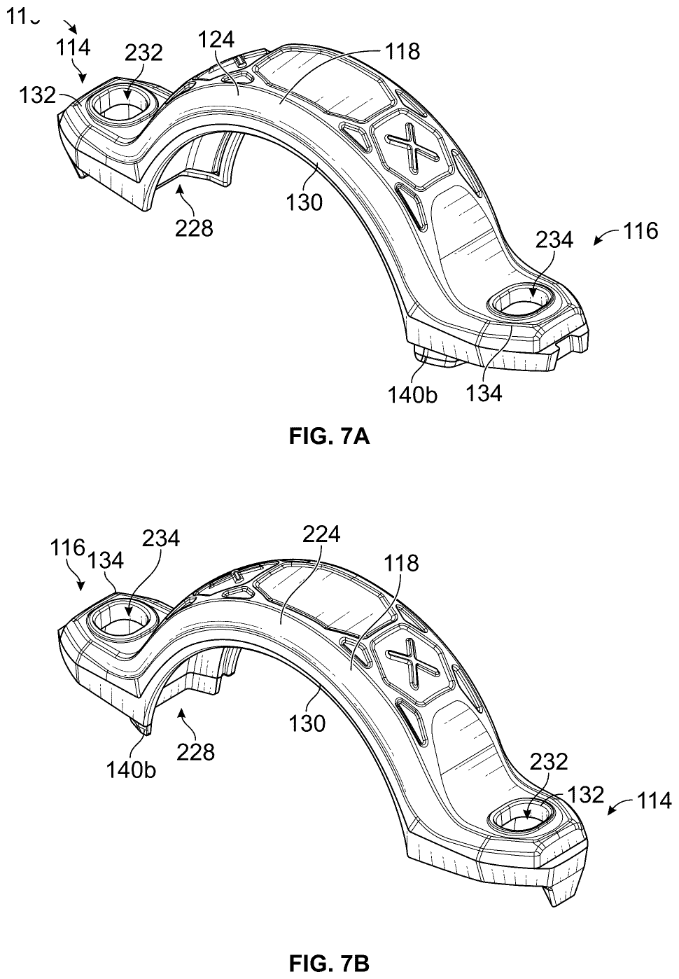

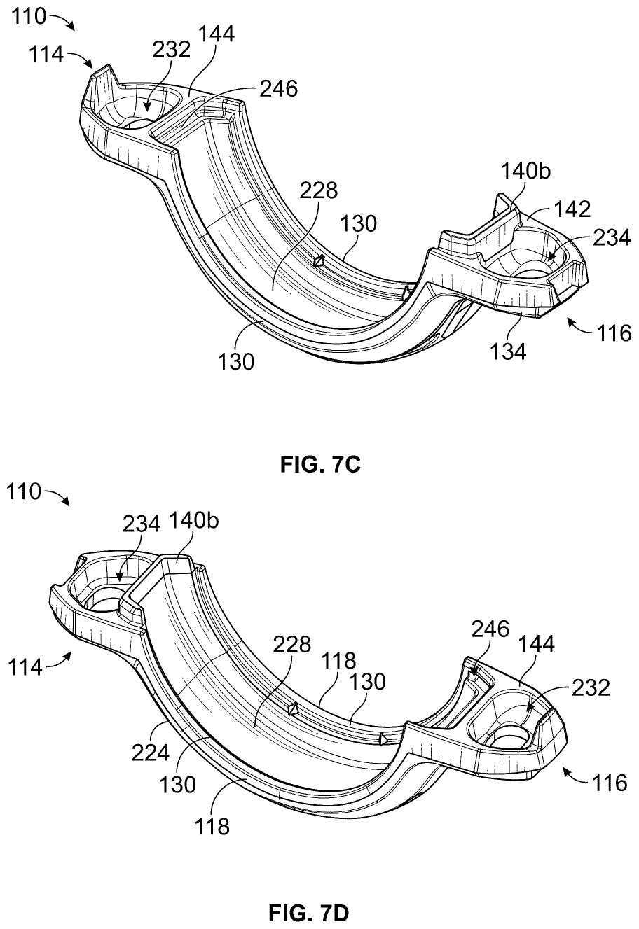

The pipe coupling 100 is illustrated in an untightened configuration in FIGS. 1 and 2, and in a tightened configuration in FIGS. 3 and 4. FIG. 3 is a side view of the example pipe coupling 100, in a tightened configuration. FIG. 4 is a side view of the example pipe coupling 100, in the tightened configuration, fitted over two pipe sections 104a, 104b to be joined. FIG. 5 is a perspective view of the example pipe coupling 100, in the untightened configuration, fitted over two pipe sections 104a, 104b to be joined. FIG. 6 is a perspective view of the example pipe coupling 100, in the tightened configuration, fitted over two pipe sections 104a, 104b to be joined. FIGS. 7A-7D illustrate perspective views of one of the coupling segments 110, 112 of the example pipe coupling.

The pipe coupling 100 includes first and second coupling segments 110, 112, and at least one installation indicator 170. The example pipe coupling 100 can be connected to the one or more pipe sections 104 or other pipe fittings. In other aspects, the pipe coupling 100 can be any suitable pipe fitting.

The example pipe coupling 100 is configured to connect a first pipe section 104a to a second pipe section 104b (shown in FIGS. 5 and 6), or to another pipe fitting. The pipe coupling 100 includes a coupling body 105, which includes a first coupling segment 110 (e.g., a first coupling segment 110) and a second coupling segment 112 (e.g., a second coupling segment 112).

In some examples, the first and second coupling segments 110, 112 are constructed from a cast material (e.g., cast iron, which may include ductile iron). In other examples, the first and second coupling segments 110, 112 are formed from another suitable material and/or a combination of materials, including but not limited to other metals, plastics, composites, and the like. The first and second coupling segments 110, 112 can be identical, such that the coupling body 105 is assembled using two identical segments. However, when assembled to form the pipe coupling 100, the first and second coupling segments 110, 112 are not mirror images across the horizontal, relative to the orientation shown. Rather, the second coupling segment 112 can be flipped about the vertical with respect to the first coupling segment 110, as illustrated. In other examples, the first and second coupling segments 110, 112 may not be complementary but not identical.

Each of the example first and second coupling segments 110, 112 are substantially C-shaped. In other examples, the coupling body 105 can include more or fewer coupling segments. In some examples, each of the first and second coupling segments 110, 112 define a first end 114, an opposing second end 116, and a central section 118 extending between the first end 114 and the second end 116. A coupling void 120 exists between the first and second coupling segments 110, 112 and, in particular, between a central section 118 of the first coupling segment 110 and a central section 118 of the second coupling segment 112. A coupling axis 122 (going into the page in FIG. 1) extends centrally through the coupling void 120. The coupling void 120 can receive opposing pipe ends 106 of the pipe sections 104 (such as the first pipe section 104a and the second pipe section 104b) to couple the first pipe section 104a to the second pipe section 104b.

Each of the first and second coupling segments 110, 112 can define an axially front end 124 and an axially rear end 224 (shown in FIGS. 5 and 6) opposite the axially front end 124. Each of the first and second coupling segments 110, 112 further defines an outer surface 126 and an inner surface 128. The inner surface 128 of the first coupling segment 110 faces the inner surface 128 of the second coupling segment 112, and the inner surfaces 128 of the first and second coupling segments 110, 112 define the coupling void 120. A coupling gasket 160 is arranged within the coupling void 120. In some examples, the inner surfaces 128 of the first and second coupling segments 110, 112 define a gasket channel 228 (shown in FIGS. 7A-7D) within which the coupling gasket 160 can be received. In an assembled and tightened configuration of the pipe coupling 100, the coupling gasket 160 is compressed or stretched between the inner surfaces 128 of the first and second coupling segments 110, 112 and an outer pipe surface 108 of the pipe sections 104 to allow the pipe coupling 100 to seal with the pipe sections 104.

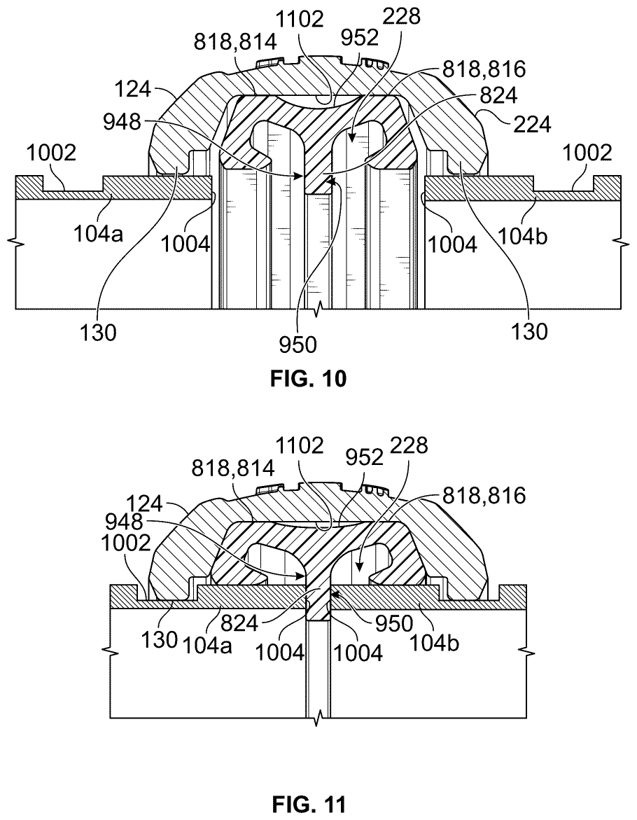

In the present aspect, each of the coupling segments 110, 112 can define an arcuate key 130 extending along the central section 118 at each of the axially front end 124 and the axially rear end 224. The gasket channel 228 can be defined axially between the opposing arcuate keys 130 formed at the axially front end 124 and the axially rear end 224 of the first and second coupling segments 110, 112. In some aspects, the first pipe section 104a and/or the second pipe section 104b can define grooved or shouldered ends 1002 (shown in FIGS. 10 and 11), and the arcuate keys 130 at the corresponding axially front end 124 and axially rear end 224 of the coupling segments 110, 112 engage the grooved or shouldered ends 1002 when the coupling segments 110, 112 are drawn together by tightening one or more coupling fasteners 150. The coupling fasteners 150 are described in further detail below.

In some examples, the arcuate keys 130 can further define gripping features, such as teeth, to grip the pipe sections 104. In other examples, the first pipe section 104a and/or second pipe section 104b can define plain ends, and the first and second arcuate keys 130 can grip the outer pipe surface 108 of the plain ends of the pipe sections 104. Plain ends refers to ends that do not define a designated groove or shoulder to be engaged by the arcuate keys 130. In some examples, either or both of the first and second coupling segments 110, 112 are configured to deform around the pipe sections 104 to ensure that the coupling segments 110,112 have properly engaged the pipe sections 104 and to ensure that the coupling gasket 160 is properly sealed against the outer pipe surface 108 of each of the pipe sections 104.

A first lug 132, or fastener pad, is formed at the first end 114 of each of the first and second coupling segments 110, 112, and a second lug 134, or fastener pad, is formed at the second end 116 of each of the first and second coupling segments 110, 112. The central section 118 of each of the first and second coupling segments 110, 112 can define a substantially arcuate shape and can extend between the corresponding first and second lugs 132, 134. The example first lug 132 of the first coupling segment 110 is substantially vertically aligned with the second lug 134 of the second coupling segment 112, relative to the orientation shown. Similarly, the second lug 134 of the first coupling segment 110 is substantially vertically aligned with the first lug 132 of the second coupling segment 112, relative to the orientation shown.

Each of the first lugs 132 can define a first fastener opening 232 (shown in FIGS. 7A-7D) formed through the first lugs 132. Similarly, each of the second lugs 134 can define a second fastener opening 234 (shown in FIGS. 7A-7D) formed through the second lugs 134. A first fastener gap 136 is defined between the aligned pair of the first fastener opening 232 of the first coupling segment 110 and the second fastener opening 234 of the second coupling segment 112, and a second fastener gap 138 is defined between the aligned pair of the first fastener opening 232 of the second coupling segment 112 and the second fastener opening 234 of the first coupling segment 110.

In the illustrated example, a first coupling tab 140a extends from the inner surface 128 of the first coupling segment 110 proximate to the second end 116 of the first coupling segment 110. Similarly, a second coupling tab 140b extends from the inner surface 128 of the second coupling segment 112 proximate to the second end 116 of the second coupling segment 112. The first and second coupling tabs 140a, 140b extend from a corresponding primary pad shoulder 142 and/or from the second lugs 134 towards the corresponding secondary pad shoulder 144 and/or the first lugs 132 of the opposing coupling segment 110, 112. The example first and second coupling tabs 140a, 140b are positioned between the corresponding first and second fastener openings 232, 234 and the central section 118 and/or the coupling void 120.

Each of the first and second coupling tabs 140a, 140b of the first coupling segment 110 can engage a corresponding coupling groove 246 (shown in FIGS. 7C and 7D) formed in a secondary pad shoulder 144 of the second coupling segment 112 when the coupling fasteners 150 are tightened. The coupling grooves 246 are formed in the inner surface 128 of the first and second coupling segment 112 proximate to the first end 114. The first and second coupling tabs 140a, 140b extend the gasket channel 228 beyond the surface of the primary pad shoulder 142. The engagement of the first and second coupling tabs 140a, 140b with the coupling grooves 246 can properly align the first coupling segment 110 with the second coupling segment 112, and can prevent the coupling gasket 160 from extruding out of the gasket channel 228 between the first and second coupling segments 110, 112.

While each of the coupling segments 110, 112 includes one coupling tab 140a, 140b and one coupling groove 246 in the illustrated example, in other examples one of the coupling segments 110, 112 may include two coupling tabs and the other of the coupling segments includes two corresponding coupling grooves.

The first and second coupling segments 110, 112 are secured together and tightened around the pipe sections 104 by the coupling fasteners 150. The example coupling fasteners 150 of FIG. 1 include a first fastener 150a and a second fastener 150b. As shown, the first fastener 150a extends through the first fastener opening 232 of the first coupling segment 110 and the second fastener opening 234 of the second coupling segment 112 to couple the first and second coupling segments 110, 112 at corresponding lugs 132, 134, and the second fastener 150b extends through the first fastener opening 232 of the second coupling segment 112 and the second fastener opening 234 of the first coupling segment 112, to couple the first and second coupling segments 110, 112 at the opposing corresponding lugs 132, 134. Each of the first and second fasteners 150a, 150b can be selectively loosened and tightened, as described in further detail below. In the illustrated example, each of the first and second fasteners 150a, 150b include a threaded bolt 152 and a threaded nut 158. The threaded bolt 152 defines a bolt head 154 and a bolt shaft 156. The bolt shaft 156 defines shaft threading 157 distal to the bolt head 154, as shown, which can threadedly engage the threaded nut 158.

The example bolt head 154 of each coupling fastener 150 faces the outer surface 126 of the first coupling segment 110, and the bolt head 154 can be sized to prohibit passage through the corresponding first and second fastener openings 232, 234. The bolt shaft 156 of the first fastener 150a extends through the corresponding first and second fastener openings 232, 234 and spans the corresponding first fastener gap 136 defined between the first lug 132 of the first coupling segment 110 and the second lug 134 of the second coupling segment 112. The bolt shaft 156 of the second fastener 150b extends through each of the first and second fastener openings 232, 234, and spans the corresponding second fastener gap 138 defined between the second lug 134 of the first coupling segment 110 and the first lug 132 of the second coupling segment 112. The threaded nut 158 of each coupling fastener 150 is threaded onto the corresponding bolt shaft 156, distal to the bolt head 154, and faces the outer surface 126 of the second coupling segment 112. The threaded nut 158 can be sized to prohibit passage through the corresponding first fastener opening 232 or second fastener opening 234 of the second coupling segment 112. To configure the pipe coupling 100 in the tightened configuration, the threaded nut 158 of each coupling fastener 150 is tightened on corresponding the bolt shaft 156 to draw the first ends 114 of the first and second coupling segments 110, 112 closer to the counterpart second ends 116 of the first and second coupling segments 110, 112. In other examples, the coupling fasteners 150 can be any other suitable fastener, including screws, torque-off bolts, cam mechanisms, bayonet connectors, rivets, and/or any other suitable fastener.

In some examples, after the first and second pipe sections 104a, 104b are inserted into the coupling gasket 160, the coupling segments 110, 112 can be assembled around a joint between the first pipe section 104a and the second pipe section 104b. In other examples, the coupling segments 110, 112 are placed onto the pipe end 106 of the first pipe section 104a in a pre-assembled configuration, in which the coupling fasteners 150 are loosened to connect the coupling segments 110, 112 together in the untightened configuration. The coupling segments 110, 112 then receive the corresponding pipe end 106 of the second pipe section 104b, and the coupling fasteners 150 can be tightened to join the first pipe section 104a to the second pipe section 104b. In other examples, pre-assembled coupling segments 110, 112 are placed onto and slid over the first pipe section 104a, the second pipe section 104b is aligned with the first pipe section 104a, and the coupling segments 110,112 can be slid back to cover the joint, before tightening the coupling fasteners 150 to clamp the coupling segments 110, 112 around the first and second pipe sections 104a, 104b.

The coupling segments 110, 112 further include one or more of the installation indicators 170 that can indicate when the pipe coupling 100 is suitably tightened in the tightened configuration. For example, coupling segments 110, 112 may include a first indicator 170a on a first end of the pipe coupling 100 and a second indicator 170b on a second end of the pipe coupling 100.

The coupling gasket 160 is constructed of a substantially resilient, flexible material. For example, the coupling gasket 160 may be a rubber material such as EPDM rubber. In other examples, the coupling gasket 160 may be or include any suitable flexible and resilient material such as, but not limited to, rubbers, foams, plastics, and the like.

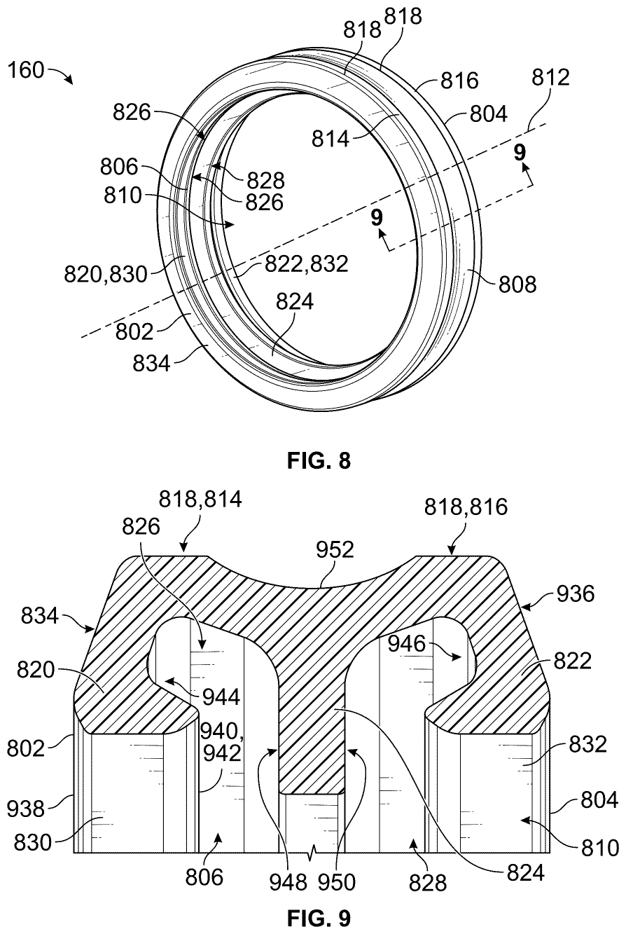

FIG. 8 illustrates a perspective view of the example coupling gasket 160, and FIG. 9 illustrates a cross-sectional view of the coupling gasket 160 taken along line 9-9. Example aspects of the coupling gasket 160 can define the gasket first axial end 802, the gasket second axial end 804, the gasket inner surface 806, and the gasket outer surface 808. The gasket inner surface 806 can define a gasket void 810, and a gasket axis 812 can extend centrally through the gasket void 810. When the pipe coupling 100 is assembled, the gasket axis 812 can be substantially coaxial with the coupling axis 122 (shown in FIG. 1). The gasket outer surface 808 defines the first gasket shoulder 814 extending radially outward at the gasket first axial end 802, the second gasket shoulder 816 extending radially outward at the gasket second axial end 804, and the substantially concave gasket center groove 952 arranged axially between the gasket shoulders 814, 816. In some examples, each of the first and second gasket shoulders 814, 816 can define a substantially flat profile at a radially outer peak 818. In other examples, the first and second gasket shoulders 814, 816 can define a substantially rounded or arcuate profile at the radially outer peaks 818.

The coupling gasket 160 further includes a first sealing ridge 820, a second sealing ridge 822, a central rib 824, a first gasket channel 826, and a second gasket channel 828. The first sealing ridge 820 extends radially inward from the first gasket shoulder 814 at the gasket first axial end 802, and the second sealing ridge 822 extends radially inward from the second gasket shoulder 816 at the gasket second axial end 804. Each of the first and second sealing ridges 820, 822 can be substantially annular and/or substantially L-shaped, as illustrated in FIG. 9. The example gasket inner surface 806 defines a first ridge sealing surface 830 of the first sealing ridge 820 and a second ridge sealing surface 832 of the second sealing ridge 822. The gasket inner surface 806 further defines the central rib 824 arranged axially between the first sealing ridge 820 and the second sealing ridge 822 and extending radially into the gasket void 810. The first gasket channel 826 is formed axially between the first sealing ridge 820 and the central rib 824, and the second gasket channel 828 is formed axially between the second sealing ridge 822 and the central rib 824.

In the illustrated example, the first sealing ridge 820 defines a first outer ridge side surface 834 angled axially outward and away from the central rib 824, and the second sealing ridge 822 defines a second outer ridge side surface 936 (shown in FIG. 9) angled axially outward and away from the central rib 824. Additionally, the first ridge sealing surface 830 of the first sealing ridge 820 is a drafted surface angled axially inward towards the central rib 824, and the second ridge sealing surface 832 of the second sealing ridge 822 is a drafted surface angled axially inward towards the central rib 824. In other examples, the first and second outer ridge side surfaces 834, 936 of the first and second sealing ridges 820, 822 are oriented substantially perpendicular to the gasket axis 812, and/or the first and second ridge sealing surfaces 830, 832 of the first and second sealing ridges 820,822 are oriented substantially parallel to the gasket axis 812 in the uncompressed configuration.

As illustrated in FIG. 9, an axially outward end 938 of each of the first and second ridge sealing surfaces 830,832 may be rounded, chamfered, or otherwise shaped to facilitate the insertion of the first and second pipe sections 104a, 104b. In some examples, an axially inward end 940 of each of the first and second ridge sealing surfaces 830, 832 terminate in a ridge tip 942. The ridge tip 942 can be substantially sharp or angular, as shown, or can be rounded or chamfered in other examples. The first and second ridge sealing surfaces 830, 832 can be configured to contact and seal with the corresponding outer pipe surfaces of the first and second pipe sections 104a, 104b, respectively, to provide a fluid-tight seal.

The example first and second gasket channels 826, 828 are arranged axially inward from, and proximate to, the first and second sealing ridges 820, 822, respectively. As illustrated in the example of FIG. 9, the first gasket channel 826 extends into a first inner ridge side surface 944 of the first sealing ridge 820 to define the L-shape of the first sealing ridge 820, and the second gasket channel 828 extends into a second inner ridge side surface 946 of the second sealing ridge 822 to define the L-shape of the second sealing ridge 822. When the first and second sealing ridges 820, 822 contact the outer pipe surfaces of the first and second pipe sections 104a, 104b, the first and second gasket channels 826, 828 allow fluid pressure to aid in sealing the corresponding first and second ridge sealing surfaces 830, 832 against the outer surfaces of the pipe sections 104a, 104b.

The example central rib 824 is arranged axially between the first and second gasket channels 826, 828 and extends radially into the gasket void 810. The central rib 824 defines a first rib side surface 948 adjacent to the first gasket channel 826 and an opposite second rib side surface 950 adjacent to the second gasket channel 828. An inward pipe edge 1004 (shown in FIGS. 10 and 11) at an end of the first pipe section 104a is configured to annularly abut and seal with the first rib side surface 948 of the central rib 824. Similarly, the inward pipe edge 1004 at the end of the second pipe section 104b is configured to annularly abut and seal with the second rib side surface 950 of the central rib 824. The sealing contact between the pipe ends of the first and second pipe sections 104a, 104b and the central rib 824 can aid in preventing or limiting fluid from flowing into the first and second gasket channels 826, 828. Moreover, the positioning of the central rib 824 between the pipe ends of the first and second pipe sections 104a, 104b maintains the inward pipe edges 1004 of the first and second pipe sections 104a, 104b in proper spacing from one another.

FIG. 10 illustrates a cross-sectional view of a portion of the pipe coupling 100 including the first coupling segment 110 and the gasket 160, in which the pipe coupling 100 is in the untightened configuration (i.e., either or both of the fasteners 150 are loosened) and the pipe ends of the first and second pipe sections 104a, 104b are not fully inserted into the coupling void 212. While the pipe coupling 100 is illustrated in the present view, in some examples, the first and second pipe sections 104a, 104b can first be assembled with the coupling gasket 160, with the 104a, 104b fully inserted into the coupling gasket 160, and the coupling segments 110, 112 of the pipe coupling 100 can then be assembled around the already-assembled coupling gasket 160 and first and second pipe sections 104a, 104b, with the arcuate keys 130 aligned axially with the annular pipe grooves 1002.

The coupling gasket 160 defines the first gasket shoulder 814 extending radially outward at the gasket first axial end 802, the second gasket shoulder 816 radially outward at the gasket second axial end 804, and the substantially concave gasket center groove 952 arcing radially inward between the first and second gasket shoulders 814, 816. The coupling gasket 160 also defines the first sealing ridge 820 extending radially inward from the first gasket shoulder 814, the second sealing ridge 822 extending radially inward from the second gasket shoulder 816, and the central rib 824 extending radially inward between the first sealing ridge 820 and the second sealing ridge 822. The first gasket channel 826 is defined between the first sealing ridge 820 and the central rib 824, and the second gasket channel 828 can be defined between the second sealing ridge 822 and the central rib 824.

The first and second pipe sections 104a, 104b include the pipe groove 1002 and the inward pipe edge 1004. To assemble the first and second pipe sections 104a, 104b with the coupling gasket 160, the pipe end of the first pipe section 104a is inserted into the gasket void 810 at the gasket first axial end 802 to abut and seal the inward pipe edge 1004 of the first pipe section 104a against the first rib side surface 948 of the central rib 824. Similarly, the pipe end of the second pipe section 104b is inserted into the gasket void 810 at the gasket second axial end 804 to abut and seal the inward pipe edge 1004 of the second pipe section 104b against the second rib side surface 950 of the central rib 824. In some examples, the central rib 824 is compressed between the inward pipe edges 1004 of the first and second pipe sections 104a, 104b. The first ridge sealing surface 830 of the first sealing ridge 820 contacts and seals against the outer pipe surface of first pipe section 104a, and the second ridge sealing surface 832 of the second sealing ridge 822 contacts and seals against the outer pipe surface of the second pipe section 104b.

After assembling the first and second pipe sections 104a, 104b with the coupling gasket 160, the coupling segments 110, 112 of the pipe coupling 100 are assembled around the coupling gasket 160 in the untightened configuration. The coupling gasket 160 is received within the gasket channel 228 between the first and second arcuate keys 130. The pipe coupling 100 is then tightened around the coupling gasket 160 and the pipe ends of the first and second pipe sections 104a, 104b. In the illustrated example, tightening the pipe coupling 100 involves threading each of the threaded nuts 158 along the corresponding threaded bolt 152 towards the bolt head 154 (shown in FIG. 1) to draw the first fastener lugs 132 towards the second lugs 134 and thereby drawing the coupling segments 110, 112 together. The tightening also reduces a diameter of the coupling void 120. Prior to tightening (e.g., in the untightened configuration), the first gasket shoulder 814 and the second gasket shoulder 816 can bias the first coupling segment away 110 from the second coupling segment 112 and/or away from the first pipe section 104a and the second pipe section 104b.

FIG. 11 illustrates a cross-sectional view of the fully assembled pipe coupling 100 in the tightened configuration. As illustrated, as the coupling segments 110, 112 are drawn together, an inner surface 1102 of the coupling segment 110 engages the gasket outer surface 808 of the coupling gasket 160 and can biases the coupling gasket 160 radially inward. The coupling gasket 160 is compressed between the pipe coupling 100 and the first and second pipe sections 104a, 104b, thereby improving the seal of the coupling gasket 160 with the first and second pipe sections 104a, 104b. More specifically, as shown, the coupling inner surface 1102 of the coupling segment 110 can engage and press against the first and second gasket shoulders 814, 816 of the coupling gasket 160 to bias the first and second sealing ridges 820, 822 radially inward against the outer pipe surfaces of the first and second pipe sections 104a, 104b. The compression of the gasket 160 against the outer pipe surfaces improves the seal between the first ridge sealing surface 830 of the first sealing ridge 820 and the outer pipe surface of the first pipe section 104a, and improves the seal between the second ridge sealing surface 832 of the second sealing ridge 822 and the outer pipe surface of the second pipe section 104b. The gasket outer surface 808 and the first and second gasket shoulders 814,816 allow the first and second sealing ridges 820, 822 to be biased further radially inward as the coupling segments 110 are tightened to accommodate pipe sections 104 of varying diameters, as opposed to traditional gaskets having a substantially flat gasket outer surface.

Moreover, when the coupling segments 110, 112 are assembled around the coupling gasket 160 and the first and second pipe sections 104a, 104b, the grooved ends of the first and second pipe sections 104a, 104b extend into the coupling void 120 at the corresponding front and rear axial ends 124, 224 of the coupling segments 110, 112. The arcuate keys 130 of the pipe coupling 100 are aligned with the corresponding annular pipe grooves 1002 formed in the outer pipe surface of the first and second pipe sections 104a, 104b. As the pipe coupling 100 is tightened and the upper and lower coupling segments 110 are drawn towards one another, the first arcuate keys 130 at the front axial ends 124 of the coupling segments 110, 112 engage the annular pipe groove 1002 and grip the outer pipe surface of the first pipe section 104a. Similarly, the second arcuate keys 130 at the rear axial ends 224 of the coupling segments 110, 112 engage the annular pipe groove 1002 and grip the outer pipe surface of the second pipe section 104b. The pipe coupling 100 is thereby clamped securely (e.g., rigidly) onto the pipe ends of the first and second pipe sections 104a, 104b, with the coupling gasket 160 providing a fluid-tight seal between the first and second pipe sections 104a, 104b. In some examples, either or both of the upper and lower coupling segments 110, 112 are configured to deform around the first and second pipe sections 104a, 104b to ensure that the coupling segments 110 have properly engaged the pipe sections 104a, 104b and to ensure that the coupling gasket 160 is properly sealed against the outer pipe surfaces of each of the first and second pipe sections 104a, 104b. In other examples, the upper and lower coupling segments 110, 112 may not deform at all around the first and second pipe sections 104a, 104b.

Conventional installation indicators involve inspecting the pipe coupling at several points on the installation, such as inspecting the gaps between the coupling segments to verify that the distances between the coupling segments are less than an upper threshold distance. For conventional pipe couplings, such inspections are required to be performed at four or more locations on the pipe coupling. However, for installations in which the pipe coupling is positioned in close proximity to other objects or structures, the installer or inspector may have difficulty with viewing the gaps or other inspection locations. The installation indicators 170 of the disclosed example pipe coupling 100 allow for complete inspection of proper tightness at only two locations. In examples in which one end of the pipe coupling is hinged instead of fastened using a fastener, the installation indicators allow for complete inspection of proper tightness at only a single location. Additionally or alternatively, the installation indicators 170 may be verified and/or inspected using tactile indications, such that the installer and/or inspector may verify proper tightness of the pipe coupling 100 without visual inspection.

Each of the example installation indicators 170a, 170b is positioned on the first lug 132 at the first end 114 of the corresponding first or second coupling segment 110, 112. As the pipe coupling 100 is tightened (e.g., by tightening the fasteners 150), the installation indicators 170a, 170b overlap corresponding indicator faces 172 of the opposing coupling segment 110, 112. For example, the indicator faces 172 include indicator faces 172a, 172 positioned on the second lug 134 at the second end 116 of the corresponding first or second coupling segment 110, 112. The installation indicators 170a, 170b and the indicator faces 172a, 172b are dimensioned such that the installation indicators 170a, 170b are in predetermined alignments with the indicator faces 172a, 172b when the pipe coupling 100 is correctly tightened. Conversely, the installation indicators 170a, 170b are not in the predetermined alignments with the indicator faces 172a, 172b when the pipe coupling 100 is not correctly tightened (e.g., overtightened or undertightened).

In disclosed examples, overlap between the installation indicators 170a, 170b and the corresponding indicator faces 172a, 172b involves the installation indicator 170a, 170b moving adjacent to the corresponding indicator face 172a, 172b so as to cover the indicator face 172a, 172b (e.g., in a direction perpendicular to movement). The overlap may, but does not necessarily, involve sliding contact between the installation indicators 170a, 170b and the corresponding indicator faces 172a, 172b during movement and/or at rest.

The example installation indicators 170 are positioned on an outer face and/or an end face of the lugs 132, and the installation faces 172 are positioned on an outer face and/or an end face of the lugs 134. The example installation indicators 170 and/or the indicator faces 172 may be monolithically formed with the coupling segments 110, 112. For example, the installation indicators 170 and/or the indicator faces 172 may be cast with the lugs 132, 134 of each of the coupling segments 110, 112 at the time of casting the coupling segments 110, 112.

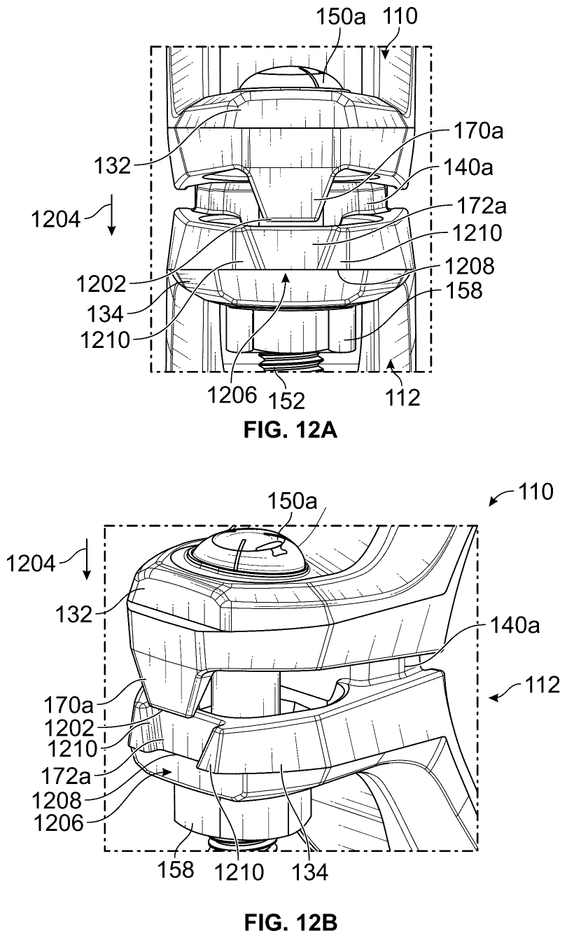

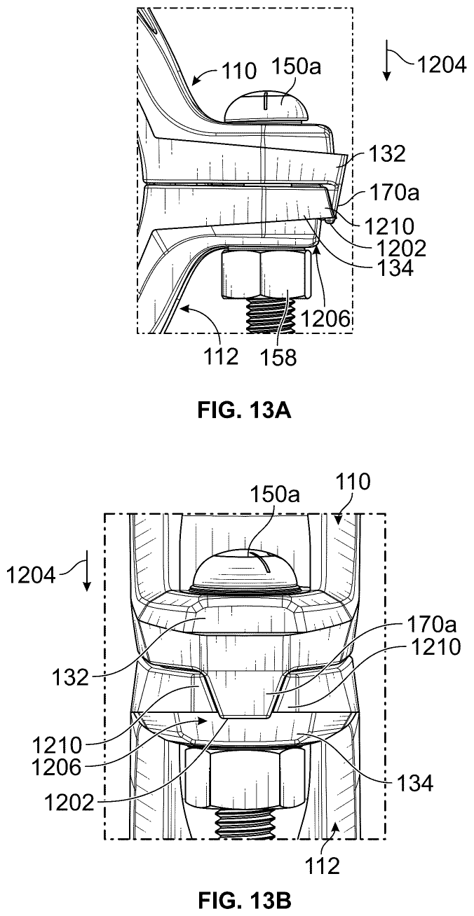

FIGS. 12A and 12B are more detailed depictions of one of the installation indicators 170a of the pipe coupling 100 of FIG. 1, in the untightened configuration. FIGS. 13A and 13B are more detailed depictions of the installation indicator 170a of the pipe coupling of FIG. 1, in the tightened configuration. In the example of FIGS. 12A-13B, the installation indicator 170a is a trapezoidal-shaped protrusion having an indicator edge 1202. The indicator edge 1202 extends perpendicular to a direction of tightening 1204. The indicator face 172a includes a counter indicator 1206 which can be compared to the position of the installation indicator 170a for determining the alignment of the installation indicator 170a and the indicator face 172a. In the example of FIGS. 12A-13B, the counter indicator 1206 is an edge 1208 (or line) in parallel with the indicator edge 1202.

As shown in FIGS. 12A-13B, the indicator face 172a is recessed with respect to the installation indicator 170a to allow the installation indicator 170a to overlap the indicator face 172a as the pipe coupling 100 is tightened. FIGS. 13A and 13B illustrate the installation indicator 170a overlapping the indicator face 172a, and the indicator edge 1202 in alignment with the counter indicator 1206. In the illustrated example, the predetermined alignment involves the indicator edge 1202 being substantially even with the edge 1208. In some examples, the pipe coupling is considered to be suitably tightened when the indicator edge 1202 is substantially even with the edge 1208 or extending beyond the edge 1208 (e.g., protruding beyond the edge 1208 in the direction of tightening 1204).

The structure of the coupling segments 110, 112, the dimensions and positioning of the installation indicators 170 and/or the indicator faces 172, and the structures of the central section 118, the arcuate key 130, and the lugs 132, 134 are tuned to result in the predetermined alignment of the indicator edge 1202 with the edge 1208 based on the final geometries of the pipe segments 104, the coupling gasket 160, and/or the pipe coupling segments 110, 112 to obtain an adequate sealing and/or coupling rigidity under specified ranges of conditions. specified for the pipe coupling installation.

In addition to observing whether the installation indicator 170a and the indicator face 172a are aligned at the indicator edge 1202 and the edge 1208, the installer and/or the inspector may additionally observe the relationship between the indicator edge 1202 and the edge 1208 tactilely. For example, the counter indicator 1206 includes lateral protrusions 1210 that do not interfere with the overlap between the installation indicator 170a and the indicator face 172a during tightening, but define a tactilely observable line along the edge 1208. When the fastener 150a is not tightened to the specified degree (e.g., position, pipe coupling geometry), the indicator edge 1202 is positioned short of the edge 1208 in the direction of tightening 1204. As a result, an installer or inspector would be capable of tactilely observing a depression, divot, gap, or recess in the counter indicator 1206 along the edge 1208. When the fastener 150a is sufficiently tightened, the example indicator edge 1202 aligns with the edge 1208. The installer or inspector would then be capable of tactilely observing the substantially even edge made up of the counter indicator 1206 and the indicator edge 1202.

In some examples, the indicator edge 1202 may be considered to be in the predetermined alignment with the edge 1208 when the indicator edge 1202 extends at least somewhat beyond the edge 1208 in the direction of tightening 1204. In such examples, the installer or inspector would then be capable of tactilely observing the protrusion of the indicator edge 1202 from the counter indicator 1206.

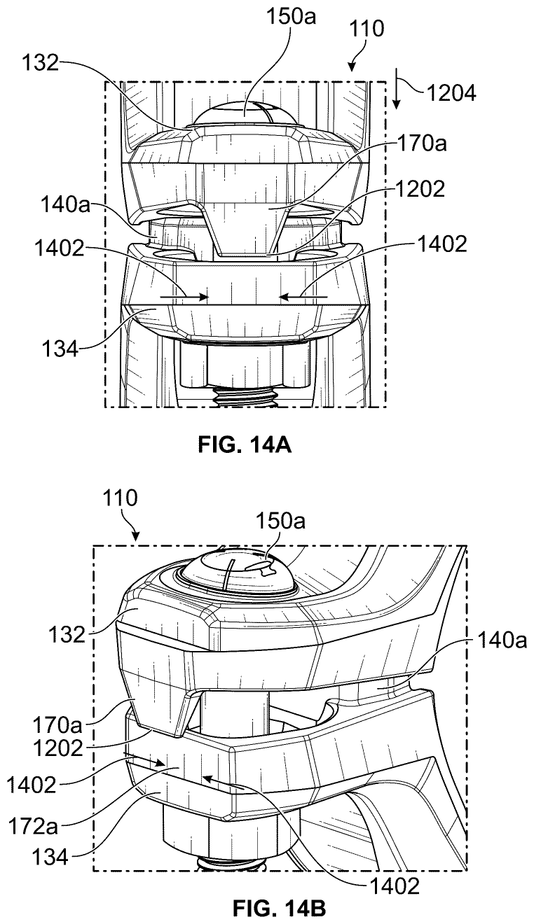

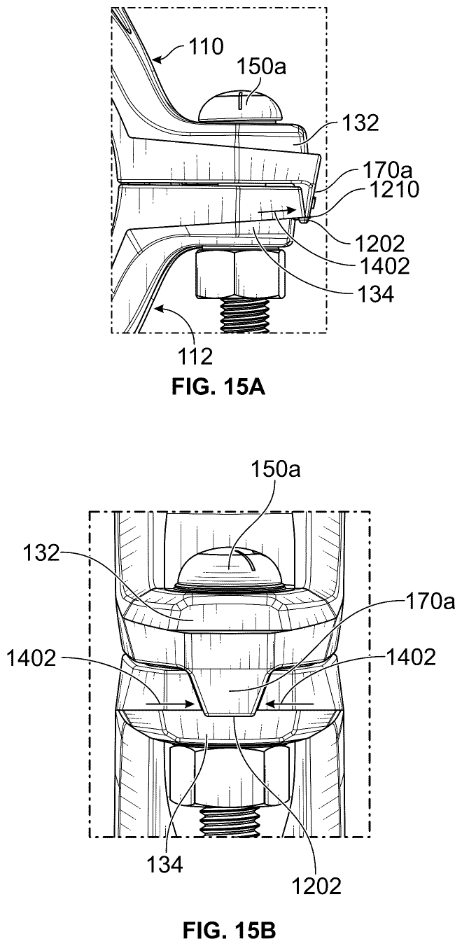

FIGS. 14A and 14B depict a second example installation indicator that may be used to implement the installation indicators 170a, 170b of the pipe coupling 100 of FIG. 1, in the untightened configuration. FIGS. 15A and 15B depict the second example installation indicator of FIGS. 14A and 14B, in the tightened configuration.

In the example of FIGS. 14A-15B, the installation indicator 170a is the same as in FIGS. 12A-13B, and includes the example indicator edge 1202 for determining alignment and proper tightening. However, instead of the example counter indicator 1206 and the example edge 1208 of FIGS. 12A-13B, the example indicator face 172a includes one or more indicator lines 1402. The indicator line(s) 1402 may be cast into the indicator face 172a, or otherwise constructed monolithically with the coupling segment 110. In other examples, the indicator line(s) 1402 may be etched, cut, or otherwise added to the indicator face 172a following construction of the coupling segment 110.

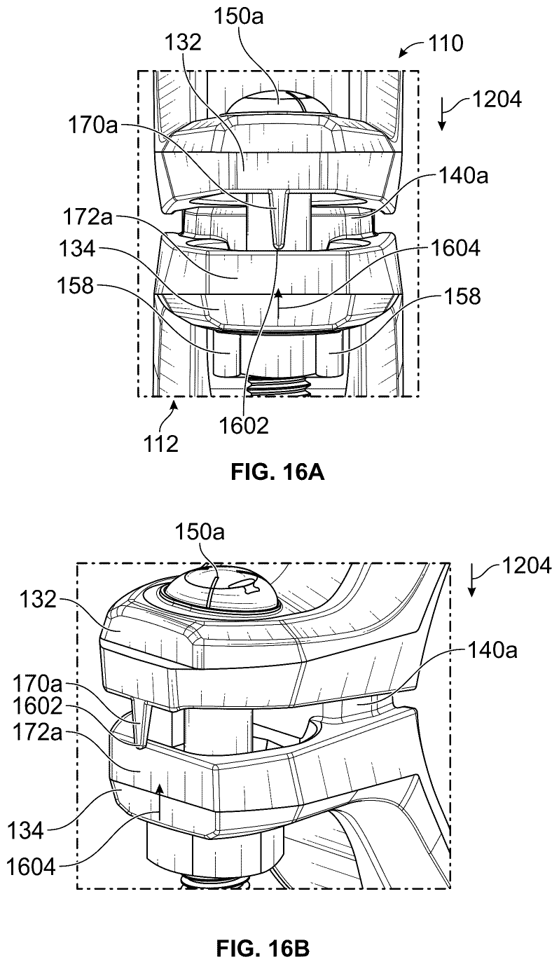

As the fastener 150a is tightened, the installation indicator 170a overlaps the indicator face 172a in the direction of tightening 1204. The indicator line(s) 1402 provide a reference with which the installer or inspector can determine whether the pipe coupling 100 is correctly tightened. For example, the indicator edge 1202 and the indicator line(s) 1402 of the illustrated example are dimensioned and positioned such that the indicator edge 1202 is aligned with the indicator line(s) 1402 when the fastener 150a is tightened to the specified degree, and is short of the indicator line(s) 1402 when the fastener 150a is tightened to less than the specified degree for proper installation. As illustrated in FIGS. 16A and 16B, the indicator edge 1202 is aligned with the indicator line(s) 1402, or extends slightly beyond the indicator line(s) 1402, in the tightened configuration. In the tightened configuration, the installation indicator 170a overlaps the indicator face 172a.

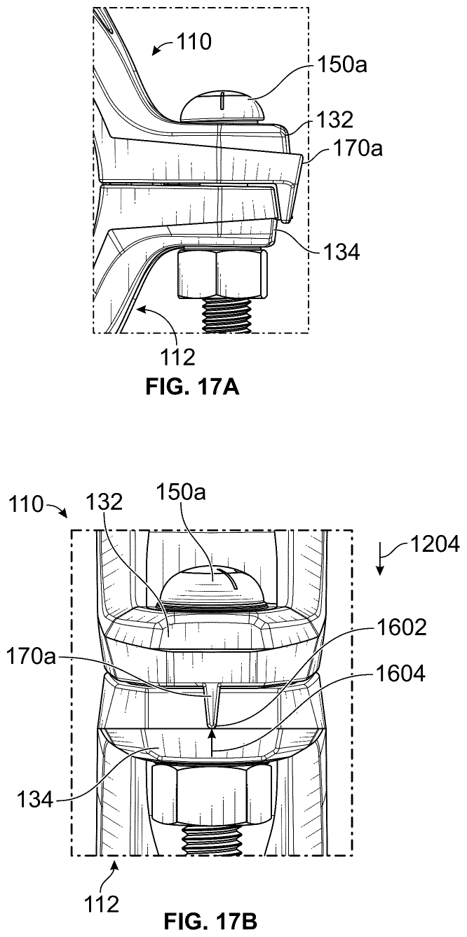

FIGS. 16A and 16B depict a third example installation indicator that may be used to implement the installation indicators 170a, 170b of the pipe coupling 100 of FIG. 1, in the untightened configuration. FIGS. 17A and 17B depict the third example installation indicator of FIGS. 16A and 16B, in the tightened configuration. In the example of FIGS. 16A-17B, the installation indicator 170a includes a point indicator 1602, and the indicator face 172a includes a point counter indicator 1604. The point indicator 1602 is cast into the coupling segment 110 (e.g., onto an end of the first lug 132) or otherwise constructed monolithically with the coupling segment 110. The point counter indicator 1604 may be cast into the indicator face 172a, or otherwise constructed monolithically with the coupling segment 110. In other examples, the point counter indicator 1604 may be etched, cut, or otherwise added to the indicator face 172a following construction of the coupling segment 110.

As the fastener 150a is tightened, the installation indicator 170a (e.g., the point indicator 1602) overlaps the indicator face 172a in the direction of tightening 1204. The point counter indicator 1604 provides a reference with which the installer or inspector can determine whether the pipe coupling 100 is correctly tightened. For example, the point indicator 1602 and the point counter indicator 1604 of the illustrated example are dimensioned and positioned such that the point indicator 1602 is aligned with the point counter indicator 1604 when the fastener 150a is tightened to the specified degree. As illustrated in FIGS. 17A and 17B, the aligned position may refer to a lack of a gap between the points of the point indicator 1602 and the point counter indicator 1604 in the direction of tightening 1204. Conversely, when the fastener 150a is tightened to less than the specified degree for proper installation (e.g., the untightened configuration shown in FIGS. 16A and 16B), a gap between the point indicator 1602 and the point counter indicator 1604 may be visible by the installer and/or the inspector.

In addition to indicating the tightness of the fasteners 150, the example point indicator 1602 and the point counter indicator 1604 may visually indicate lateral shifting between the first lug 132 and the second lug 134, which may represent twisting or other shifting between the coupling segments 110, 112.

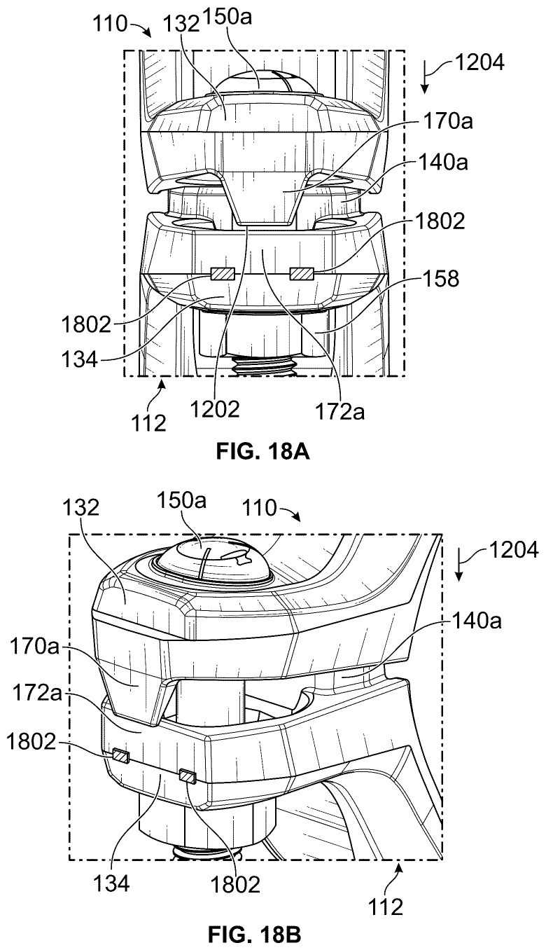

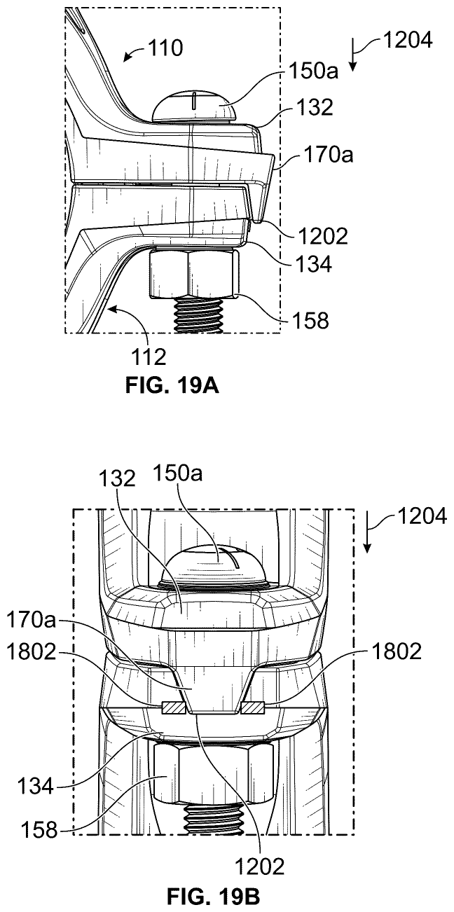

FIGS. 18A and 18B depict a fourth example installation indicator that may be used to implement the installation indicators of the pipe coupling of FIG. 1, in the untightened configuration. FIGS. 19A and 19B depict the fourth example installation indicator of FIGS. 17A and 17B, in the tightened configuration. In the example of FIGS. 18A-19B, the installation indicator 170a is the same as in FIGS. 12A-13B, and includes the example indicator edge 1202 for determining alignment and proper tightening. However, instead of the example counter indicator 1206 and the example edge 1208 of FIGS. 12A-13B, the example indicator face 172a includes one or more range indicator(s) 1802. The range indicator(s) 1802 may be cast into the indicator face 172a, or otherwise constructed monolithically with the coupling segment 110. In other examples, the range indicator(s) 1802 may be etched, cut, or otherwise added to the indicator face 172a following construction of the coupling segment 110.

The example range indicator(s) 1802 may operate similarly to the edge 1208 of FIGS. 12A-13B, except that the pipe coupling 100 may be considered to be the tightened configuration when the indicator edge 1202 is aligned with any portion of the range indicator(s) 1802. Instead of a line-type of counter indicator, the range indicator(s) 1802 provide a range of tightening (e.g., position, pipe coupling geometry) that correspond to the depth of the range indicator(s) 1802.

As the fastener 150a is tightened, the installation indicator 170a (e.g., the indicator edge 1202) overlaps the indicator face 172a in the direction of tightening 1204. The range indicator(s) 1802 provide a reference with which the installer or inspector can determine whether the pipe coupling 100 is correctly tightened. For example, the indicator edge 1202 and the range indicator(s) 1802 of the illustrated example are dimensioned and positioned such that the indicator edge 1202 is aligned with any section of the range indicator(s) 1802 when the fastener 150a is tightened within the specified range. Conversely, when the fastener 150a is tightened to less than the specified degree for proper installation (e.g., the untightened configuration shown in FIGS. 18A and 18B), the indicator edge 1202 is not aligned within the range indicator(s) 1802 (e.g., either short of or beyond the range indicator(s) 1802 in the direction of tightening 1204).

When constructed accordingly, the example range indicator(s) 1802 may be particularly useful in allowing the pipe coupling 100 to securely couple certain types of out-of-spec pipe. Such coupling of out-of-spec pipe would involve determining the types of out-of-spec pipe that could be supported by the coupling, specifying the lower and upper tightening limits corresponding to the range indicator(s) 1802 to support the coupling, and constructing the coupling segments 110, 112 to include the indicator edge 1202 and the range indicator(s) 1802 at the corresponding locations.

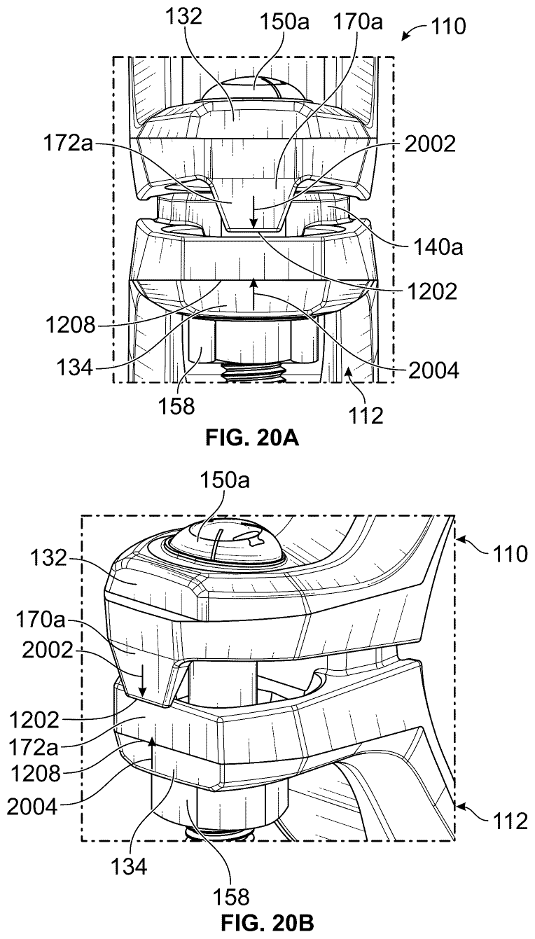

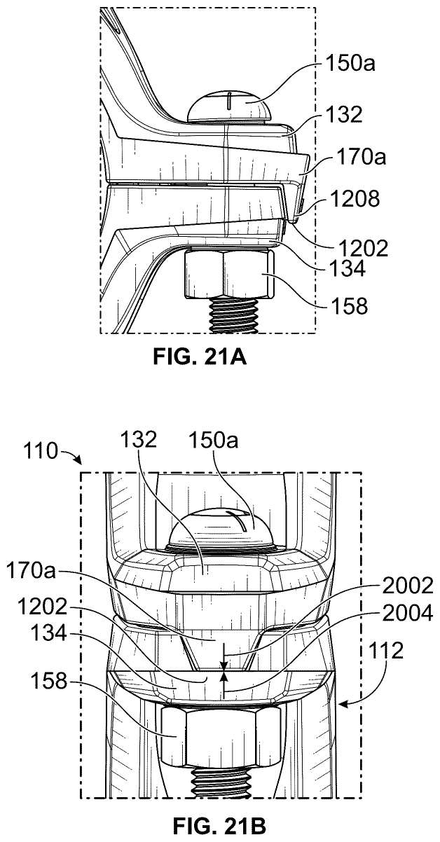

In some examples, the installation indicators 170a, 170b may include a combination of types of indicators, such as both point and line indicators. FIGS. 20A and 20B depict a fifth example installation indicator that may be used to implement the installation indicators of the pipe coupling of FIG. 1, in the untightened configuration. FIGS. 21A and 21B depict the fifth example installation indicator of FIGS. 20A and 20B, in the tightened configuration. In the example of FIGS. 20A-21B, the installation indicator 170a includes a point indicator 2002 in addition to the indicator edge 1202, and the indicator face 172a includes a point counter indicator 2004 in addition to the counter indicator 1206 and the edge 1208. The point indicator 2002 is cast into the coupling segment 110 (e.g., onto an end of the first lug 132) or otherwise constructed monolithically with the coupling segment 110. The point counter indicator 2004 may be cast into the indicator face 172a, or otherwise constructed monolithically with the coupling segment 110. In other examples, the point indicator 2002 and/or the point counter indicator 2004 may be etched, cut, or otherwise added to the indicator face 172a following construction of the coupling segment 110.

The point indicator 2002 and the point counter indicator 2004 operate similarly to the point indicator 1602 and the point counter indicator 1604 described above with reference to FIGS. 16A-17B. The installer or inspector may use either or both types of indicators on the example installation indicator 170a for visual and/or tactile inspection and verification. The pipe coupling 100 may nevertheless be visually and/or tactilely verified using a single visual reference for each end of the pipe coupling 100 (or each end of the pipe coupling that includes a fastener 150).

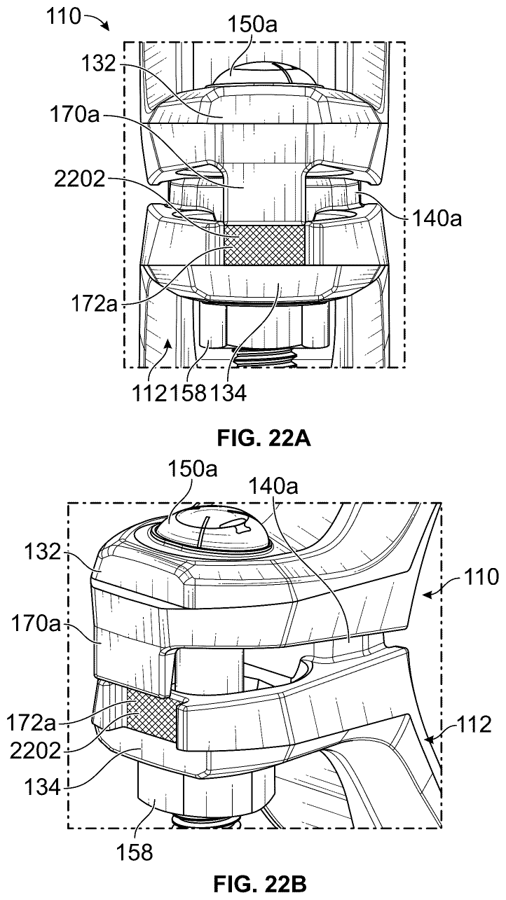

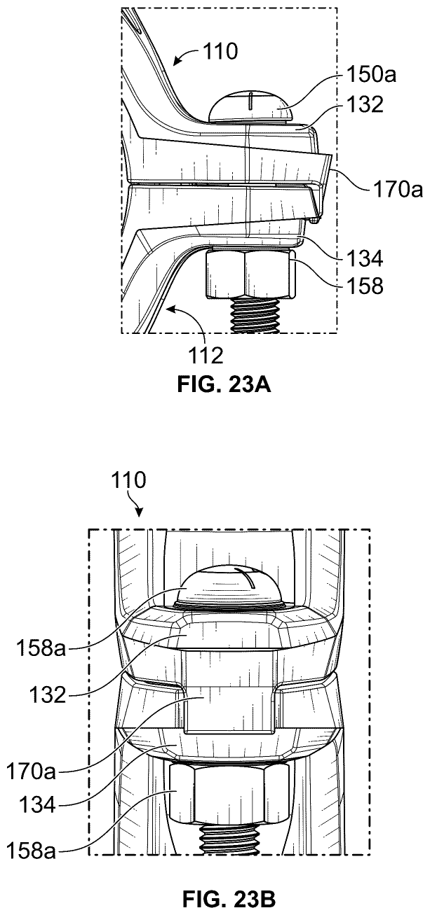

FIGS. 22A and 22B depict a sixth example installation indicator that may be used to implement the installation indicators of the pipe coupling of FIG. 1, in the untightened configuration. FIGS. 23A and 23B depict the sixth example installation indicator of FIGS. 22A and 22B, in the tightened configuration. In the example of FIGS. 22A-23B, the installation indicator 170a is the same as in FIGS. 12A-13B. However, instead of the example counter indicator 1206 and the example edge 1208 of FIGS. 12A-13B, the example indicator face 172a includes texturing 2202. The texturing 2202 of the indicator face 172a may be cast into the indicator face 172a, or otherwise constructed monolithically with the coupling segment 110. In other examples, the range indicator(s) 1802 may be etched, cut, painted, or otherwise added to the indicator face 172a following construction of the coupling segment 110. The texturing 2202 may be visual texturing, tactile texturing, or both.

While the fastener 150a is untightened, the texturing 2202 on the indicator face 172a is exposed to both visual and tactile observation. As the fastener 150a is tightened, the installation indicator 170a overlaps the indicator face 172a in the direction of tightening 1204 and progressively covers the texturing 2202. When the fastener 150a is tightened to the specified degree, the texturing 2202 of the example indicator face 172a is completely covered by the installation indicator 170a and cannot be observed by the installer or inspector, thereby indicating the tightened configuration has been achieved. Conversely, when the fastener 150a is tightened to less than the specified degree for proper installation (e.g., the untightened configuration shown in FIGS. 22A and 22B), at least a portion of the texturing 2202 is exposed to visual and/or tactile observation, thereby indicating to the installer and/or the inspector that the pipe coupling is in the untightened configuration or an incompletely tightened configuration.

The example installation indicator 170b and the indicator face 172b on the opposite side of the pipe coupling 100 may be identical to the installation indicator 170a and the indicator face 172a. However, the direction of tightening 1204 may be reversed between the different installation indicators 170a, 170b when the first and second coupling segments 110, 112 are identical. In other examples, such as when the first or second coupling segment 110, 112 includes both installation indicators 170a, 170b and the other of the first or second coupling segment 110, 112 includes both indicator faces 172a, 172b, the direction of tightening may be the same on both sides of the pipe coupling.

While example installation indicators 170 are disclosed above with reference to an example style of pipe coupling, the disclosed example installation indicators 170 and other types of installation indicators falling within the scope of the disclosure may be used with other types or styles of pipe coupling.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Many variations and modifications may be made to the above-described examples without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

What is claimed is:

1. A pipe coupling comprising:
a coupling body comprising a first coupling segment and a second coupling segment, the first coupling segment having a first lug on a first end and the second coupling segment having a second lug opposite the first lug;
a first fastener mounted to the coupling body via the first and second lugs and configured to tighten the pipe coupling; and
a first installation indicator on the first lug and arranged to overlap a first indicator face of the second lug as the pipe coupling is tightened, wherein the first installation indicator is in a predetermined alignment with a first counter indicator on the second lug when the pipe coupling is correctly-tightened and is not in the predetermined alignment with the first counter indicator when the pipe coupling is under tightened.

2. The pipe coupling as defined in claim 1, wherein the first installation indicator of the first lug comprises a cast protrusion and the first counter indicator of the second lug comprises a cast indicator.

3. The pipe coupling as defined in claim 1, wherein the first installation indicator is on an outer face of the first lug and the first indicator face is on an outer face of the second lug.

4. The pipe coupling as defined in claim 1, wherein the first installation indicator comprises at least one of a point or a first line perpendicular to a direction of tightening of the pipe coupling.

5. The pipe coupling as defined in claim 4, wherein the first counter indicator comprises a second line perpendicular to the direction of tightening of the pipe coupling.

6. The pipe coupling as defined in claim 4, wherein the first counter indicator comprises a point.

7. The pipe coupling as defined in claim 4, wherein the first counter indicator comprises a range in the direction of tightening of the pipe coupling, wherein the first installation indicator has the predetermined alignment with the first counter indicator when the first installation indicator is within the range.

8. The pipe coupling as defined in claim 1, wherein the first coupling segment has a third lug on a second end and the second coupling segment has a fourth lug opposite the third lug, the pipe coupling further comprising:
a second fastener mounted to the coupling body via the third and fourth lugs and configured to tighten the pipe coupling; and
a second installation indicator on the fourth lug and arranged to overlap a second indicator face of the third lug as the pipe coupling is tightened, wherein the second installation indicator is in a predetermined alignment with a second counter indicator on the third lug when the pipe coupling is correctly tightened and is not in the predetermined alignment with the second counter indicator when the pipe coupling is under tightened.

9. The pipe coupling as defined in claim 8, wherein the first coupling segment and the second coupling segment are identical.

10. The pipe coupling as defined in claim 1, wherein the first coupling segment and the second coupling segment each comprise a gasket groove, wherein the pipe coupling further comprises a gasket disposed within the gasket groove.

11. A pipe coupling, comprising:
a coupling body comprising a first coupling segment and a second coupling segment, the first coupling segment having a first lug and a second lug, and the second coupling segment having a third lug opposite the first lug and a fourth lug opposite the second lug;
a first fastener mounted to the coupling body via the first and third lugs, and a second fastener mounted to the coupling body via the second and fourth lugs, the first and second fasteners configured to tighten the pipe coupling; and
installation indicators on the first coupling segment and the second coupling segment, the installation indicators configured to completely visually indicate when the pipe coupling is in a tightened configuration at two locations on the pipe coupling.

12. The pipe coupling as defined in claim 11, wherein the installation indicators are cast into the first and second coupling segments.

13. The pipe coupling as defined in claim 11, wherein the installation indicators are on respective outer faces of the first lug and the second lug.

14. The pipe coupling as defined in claim 11, wherein the installation indicators completely visually indicate when the pipe coupling is in a tightened configuration by a predetermined alignment of the installation indicators.

15. The pipe coupling as defined in claim 11, wherein the installation indicators are configured to visually indicate that the pipe coupling is in the tightened configuration by a lack of a gap between the installation indicators.

16. The pipe coupling as defined in claim 11, wherein the installation indicators are configured to be in an overlapping arrangement in the tightened configuration.

17. The pipe coupling as defined in claim 11, wherein the installation indicators are configured to visually indicate that the pipe coupling is in the tightened configuration by a lack of visibility of a predetermined visual indicator.

18. The pipe coupling as defined in claim 11, wherein the installation indicators are further configured to tactilely indicate when the pipe coupling is in a tightened configuration at two locations on the pipe coupling.

19. The pipe coupling as defined in claim 11, wherein the first coupling segment and the second coupling segment are identical.

20. The pipe coupling as defined in claim 11, wherein the installation indicators further visually indicate when the pipe coupling is not in the tightened configuration.

21. A pipe coupling comprising:
a coupling body comprising a first coupling segment and a second coupling segment, the first coupling segment having a first lug on a first end and the second coupling segment having a second lug opposite the first lug;
a first fastener mounted to the coupling body via the first and second lugs and configured to tighten the pipe coupling; and
a first installation indicator on the first lug and arranged to overlap a first indicator face of the second lug as the pipe coupling is tightened, wherein the first installation indicator and a first counter indicator on the second lug provide a first tactile indication when the pipe coupling is correctly-tightened and a second tactile indication when the pipe coupling is under tightened.

22. The pipe coupling as defined in claim 21, wherein the first installation indicator of the first lug comprises a cast protrusion and the first counter indicator of the second lug comprises a cast indicator.

23. The pipe coupling as defined in claim 21, wherein the first installation indicator is on an outer face of the first lug and the first indicator face is on an outer face of the second lug.

24. The pipe coupling as defined in claim 21, wherein the first installation indicator comprises at least one of a point or a first line perpendicular to a direction of tightening of the pipe coupling.

25. The pipe coupling as defined in claim 24, wherein the first counter indicator comprises a second line perpendicular to the direction of tightening of the pipe coupling.

26. The pipe coupling as defined in claim 24, wherein the first counter indicator comprises a point.

27. The pipe coupling as defined in claim 21, wherein the first counter indicator has a texture etched or cut into the first indicator face.

28. The pipe coupling as defined in claim 21, wherein the first coupling segment has a third lug on a second end and the second coupling segment has a fourth lug opposite the third lug, the pipe coupling further comprising:
a second fastener mounted to the coupling body via the third and fourth lugs and configured to tighten the pipe coupling; and
a second installation indicator on the fourth lug and arranged to overlap a second indicator face of the third lug as the pipe coupling is tightened, wherein the second installation indicator and a second counter indicator provide a third tactile indication when the pipe coupling is correctly-tightened and a fourth tactile indication when the pipe coupling is under tightened.

29. The pipe coupling as defined in claim 28, wherein the first coupling segment and the second coupling segment are identical.

30. The pipe coupling as defined in claim 21, wherein the first coupling segment and the second coupling segment each comprise a gasket groove, wherein the pipe coupling further comprises a gasket disposed within the gasket groove.

31. A pipe coupling, comprising:
a coupling body comprising a first coupling segment and a second coupling segment, the first coupling segment having a first lug and a second lug, and the second coupling segment having a third lug opposite the first lug and a fourth lug opposite the second lug;
a first fastener mounted to the coupling body via the first and third lugs, and a second fastener mounted to the coupling body via the second and fourth lugs, the first and second fasteners configured to tighten the pipe coupling; and
installation indicators on the first coupling segment and the second coupling segment, the installation indicators configured to completely tactilely indicate when the pipe coupling is in a tightened configuration at two locations on the pipe coupling.

32. The pipe coupling as defined in claim 31, wherein the installation indicators are cast into the first and second coupling segments.

33. The pipe coupling as defined in claim 31, wherein the installation indicators are on respective outer faces of the first lug and the second lug.

34. The pipe coupling as defined in claim 31, wherein the installation indicators completely tactilely indicate when the pipe coupling is in a tightened configuration by a predetermined alignment of the installation indicators.

35. The pipe coupling as defined in claim 31, wherein the installation indicators are configured to tactilely indicate that the pipe coupling is in the tightened configuration by a lack of a gap between the installation indicators.

36. The pipe coupling as defined in claim 31, wherein the installation indicators are configured to be in an overlapping arrangement in the tightened configuration.

37. The pipe coupling as defined in claim 31, wherein the installation indicators are configured to tactilely indicate that the pipe coupling is in the tightened configuration by a lack of accessibility of a predetermined tactile indicator.

38. The pipe coupling as defined in claim 31, wherein the installation indicators are further configured to tactilely indicate when the pipe coupling is in a tightened configuration at two locations on the pipe coupling.

39. The pipe coupling as defined in claim 31, wherein the first coupling segment and the second coupling segment are identical.

40. The pipe coupling as defined in claim 31, wherein the installation indicators further tactilely indicate when the pipe coupling is not in the tightened configuration.
